(19) United States
(12) Patent Application Publication
(10) Pub. No.: US 2012/0290727 A1
(43) Pub. Date: Nov. 15, 2012

(54) METHOD AND SYSTEM FOR INCREASING PERFORMANCE OF TRANSMISSION CONTROL PROTOCOL SESSIONS IN DATA NETWORKS

(75) Inventor: Constantin Tivig, Toronto (CA)

(73) Assignee: BCE INC., Montreal, QC (CA)

(21) Appl. No.: 13/519,790

(22) PCT Filed: Dec. 30, 2010
(86) PCT No.: PCT/CA2010/002042

§ 371 Date: Jun. 28, 2012

Related U.S. Application Data
(60) Provisional application No. 61/291,489, filed on Dec. 31, 2009.

(51) Int. Cl. G06F 15/16

(52) U.S. Cl. 709/227

(57) ABSTRACT

A method for increasing the performance of a transmission control protocol (TCP) session transmitted over a telephony local loop between a client and a server. The method comprises: providing a proxy system between the client and the server, the client and the server being coupled through a network; intercepting, at the proxy system, a request transmitted by the client; transparently establishing a first TCP session between the client and the proxy system, and a second TCP session between the proxy system and the server; and storing data, received from the server in response to the request, in a buffer at the proxy system, when throughput between the server and proxy system is greater than throughput between the proxy system and the client.

### CROSS REFERENCE TO RELATED APPLICATIONS

This application claims the benefit of Provisional Application No. 61/291,489, filed on Dec. 31, 2009, the entire contents of which is incorporated herein by reference.

### FIELD OF THE INVENTION

The present invention relates generally to transmission control protocol (TCP). In particular, the present invention relates to a method and system for transparent TCP proxy.

### BACKGROUND OF THE INVENTION

TCP is a set of rules that is used with Internet Protocol (IP) to send data in the form of message units between computers over the Internet. IP handles the actual delivery of the data, while TCP tracks the individual units of data (packets) into which a message is divided for efficient routing through the Internet.

TCP is a connection-oriented protocol. A connection, otherwise known as a TCP session, is established and maintained until such time as the message or messages have been exchanged by the application programs at each end of the session. TCP is responsible for ensuring that a message is divided into the packets that IP manages and for reassembling the packets back into the complete message at the other end.

Due to network congestion, traffic load balancing, or other unpredictable network behavior, IP packets can be lost or delivered out of order. TCP detects these problems, requests retransmission of lost packets, rearranges out-of-order packets, and even helps minimize network congestion to reduce the occurrence of the other problems. When a TCP receiver has finally reassembled a perfect copy of the data originally transmitted, the TCP receiver passes the data to an application program. TCP uses a number of mechanisms to achieve high performance and avoid “congestion collapse”, where network performance can fall by several orders of magnitude. These mechanisms control the rate of data entering the network, keeping the data flow below a rate that would trigger collapse.

Improving throughput and congestion control in TCP systems continues to be desirable.

### SUMMARY

According to one aspect there is provided herein a method for increasing the performance of a transmission control protocol (TCP) session transmitted over a telephony local loop between a client and a server. In various embodiments, the method comprises providing a proxy system between the client and the server; intercepting, at the proxy system, a request transmitted by the client; transparently establishing a first TCP session between the client and the proxy system, and a second TCP session between the proxy system and the server; and storing data, received from the server in response to the request, in a buffer at the proxy system, when throughput between the server and proxy system is greater than throughput between the proxy system and the client. In various embodiments, the client and the server are coupled through a network. In some embodiments, the network comprises: a telephony local loop, an internet backbone, and an IP network layer between the telephony local loop and the internet backbone. In various embodiments, the IP network layer has a first edge and the first edge has a first interface. In some embodiments, the IP network layer is coupled to the client through the first interface. In some embodiments, the client is coupled to the telephony local loop. In some embodiments, the server is coupled to the client through the internet backbone. In various embodiments the proxy system is situated at the first edge of the IP network layer.

In some embodiments, the proxy system resides at the first interface.

In some embodiments, the network further comprises: an aggregation network layer. In some embodiments, the aggregation network layer is a non-IP network layer. In various embodiments, the aggregation network layer is coupled between the telephony local loop and the first edge of the IP network layer. In various embodiments, the aggregation network layer is coupled to the IP network layer at the first interface.

In some embodiments, the proxy system resides at the first interface.

In some embodiments, the first interface comprises a broadband remote access server (BRAS) and the proxy system resides at the BRAS.

In various embodiments, the method further comprises: in response to data received from the client at the proxy system: transmitting the data from the proxy system to the server; and prior to receiving an acknowledgment from the server at the proxy system, transmitting an acknowledgment from the proxy system to the client.

In some embodiments, the acknowledgment transmitted by the proxy system appears to originate from the server. In various embodiments, the acknowledgement is formatted such that it appears to originate from the server.

In various embodiments, the method further comprises monitoring the round trip delay time (RTT) of the TCP session between the proxy system and the server.

In some embodiments, the method further comprises: identifying a congestion event when the RTT exceeds a threshold; and if a congestion event has been identified, transmitting data from the buffer to the client during the congestion event to maintain throughput between the proxy system and the client.

In some embodiments, the method further comprises selecting a TCP window size to maximize throughput.

In some embodiments, the method further comprises caching web content at the proxy system.

In another aspect, a system for increasing the performance of a transmission control protocol (TCP) session transmitted over a telephony local loop between a client and a server is provided herein. In various embodiments, the system comprises a proxy system between the client and the server. In various embodiments, the proxy system comprises a buffer memory; and a processor. In some embodiments, the processor is configured to: intercept, at the proxy system, a request transmitted by the client; transparently establish a first TCP session between the client and the proxy system, and a second TCP session between the proxy system and the server; and store data, received from the server in response to the request, in the buffer memory, when throughput between the server and proxy system is greater than throughput between the proxy system and the client. In various embodiments, the client and the server are coupled through a network. In some embodiments, the network comprises: a telephony local loop, an internet backbone, and an IP network layer between the telephony local loop and the internet backbone. In various embodiments, the IP network layer has a first edge. In some embodiments, the first edge comprises a first interface. In some embodiments, the IP network layer is coupled to the client through the first interface. In some embodiments, the client is coupled to the telephony local loop. In some embodiments, the server being coupled to the client through the internet backbone. In some embodiments, the proxy system is situated at the first edge of the IP network layer.

In some embodiments, the proxy system resides at the first interface.

In some embodiments, the network further comprises: an aggregation network layer. In some embodiments, the aggregation network layer is a non-IP network layer. In various embodiments, the aggregation network layer is coupled between the telephony local loop and the first edge of the IP network layer. In various embodiments, the aggregation network layer is coupled to the IP network layer at the first interface.

In some embodiments, the proxy system resides at the first interface.

In some embodiments, the first interface comprises a broadband remote access server (BRAS) and the proxy system resides at the BRAS. In some embodiments, the proxy system comprises a component of the BRAS.

In various embodiments, the processor is further configured to: in response to data received from the client at the proxy system: transmit the data from the proxy system to the server; and prior to receiving an acknowledgment from the server at the proxy system, transmit an acknowledgment from the proxy system to the client.

In some embodiments, the processor is further configured to transmit the acknowledgement such that the acknowledgment appears to originate from the server. In some embodiments, the processor is further configured to format the acknowledgement such that the acknowledgment appears to originate from the server.

In some embodiments, the processor is further configured to monitor the round trip delay time (RTT) of the TCP session between the proxy system and the server.

In some embodiments, the processor is further configured to: identify a congestion event when the RTT exceeds a threshold; and if a congestion event has been identified, transmit data from the buffer to the client during the congestion event to maintain throughput between the proxy system and the client.

In some embodiments, the processor is further configured to select a TCP window size to maximize throughput.

In some embodiments, the processor is further configured to cache web content at the proxy system.

In another aspect, a method for increasing the performance of a transmission control protocol (TCP) session transmitted over a telephony local loop between a client and a server is provided herein. In various embodiments, the method comprises: providing a proxy system between the client and the server, the client and the server being coupled through a network; intercepting, at the proxy system, a request transmitted by the client; transparently establishing a first TCP session between the client and the proxy system, and a second TCP session between the proxy system and the server; and storing data, received from the server in response to the request, in a buffer at the proxy system, when throughput between the server and proxy system is greater than throughput between the proxy system and the client.

### BRIEF DESCRIPTION OF THE DRAWINGS

Embodiments of the present invention will now be described, by way of example only, with reference to the attached Figures, wherein:

FIG. 1 is a schematic diagram of a network with which embodiments described herein may be used;

FIG. 2 is a schematic diagram of a typical transmission control protocol TCP session between a client and a server;

FIG. 3 is a schematic diagram of the data flow between a client and a server;

FIG. 4 is a graph showing speed versus the round trip delay time (RTT) of source of content;

FIG. 5A is a schematic diagram of a network;

FIG. 5B is a schematic diagram of a queue of a network device of the network of FIG. 5B;

FIG. 6 is graph illustrating various parameters as a function of congestion;

FIG. 7 is a schematic diagram of a system for providing a TCP session between a client and server according to various embodiments;

FIG. 8, which is schematic diagram of the data flow in the system of FIG. 7 according to various embodiments;

FIGS. 9A to 9C are schematic diagrams of various TCP sessions between a sender and a recipient;

FIG. 10 is a block diagram of the proxy system of FIG. 7 according to various embodiments;

FIG. 11 is a schematic diagram of the memory of the proxy system of FIG. 10;

FIG. 12 is a flow chart diagram illustrating a method performed by the system of FIG. 7 according to various embodiments; and

FIG. 13 is a flow chart diagram illustrating a method performed by the system of FIG. 7 according to various embodiments.

### DETAILED DESCRIPTION

In the following description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention. For example, specific details are not provided as to whether the embodiments of the invention described herein are implemented as a software routine, hardware circuit, firmware, or a combination thereof.

A transparent TCP overlay network and a TCP proxy is provided herein. The TCP proxy comprises a system that resides in a traffic path and controls and manipulates traffic flow in order to increase both the instantaneous and overall performance of TCP content delivery. The system acts as a proxy between a client and a server in a TCP session. Once a client initiates a TCP session to the server, the system takes over the TCP session, transparently. The client's TCP session terminates on the system and the system initiates a TCP session to the server on the client's behalf.

Generally, the present invention provides a method for increasing performance of a transmission control protocol (TCP) session by intercepting, at a proxy system, a request transmitted by a client; transparently establishing a first TCP session between the client and the proxy system, and a second TCP session between the proxy system and the server; and storing data, received from the server in response to the request, in a buffer at the proxy system, when throughput between the server and proxy system is greater than throughput between the proxy system and the client. The throughput between the proxy system and the client can be maintained by transmitting the data stored in the buffer when the throughput between the server and proxy system falls below the throughput between the proxy system and the client. Storing data received from the server can comprise storing data received until a buffer full condition is received from the buffer. The method can also further comprise caching the data at the proxy system, monitoring a round trip time (RTT) for the TCP session, and/or entering a congestion avoidance mode when the RTT is greater than a predetermined threshold value. The method can be implemented in a transparent TCP proxy.

The present method and system increase and sustain throughput for each TCP session (e.g. by buffering, caching and breaking end to end delay into smaller delays) thereby improving customer experience (FTP, video content delivery, P2P, web etc).

As is known, TCP systems can use proxy servers. A proxy server is a server (a computer system or an application program) that acts as an intermediary for requests from clients seeking resources from other servers. A proxy server can be placed in the client's local computer or at various points between the user and the destination servers.

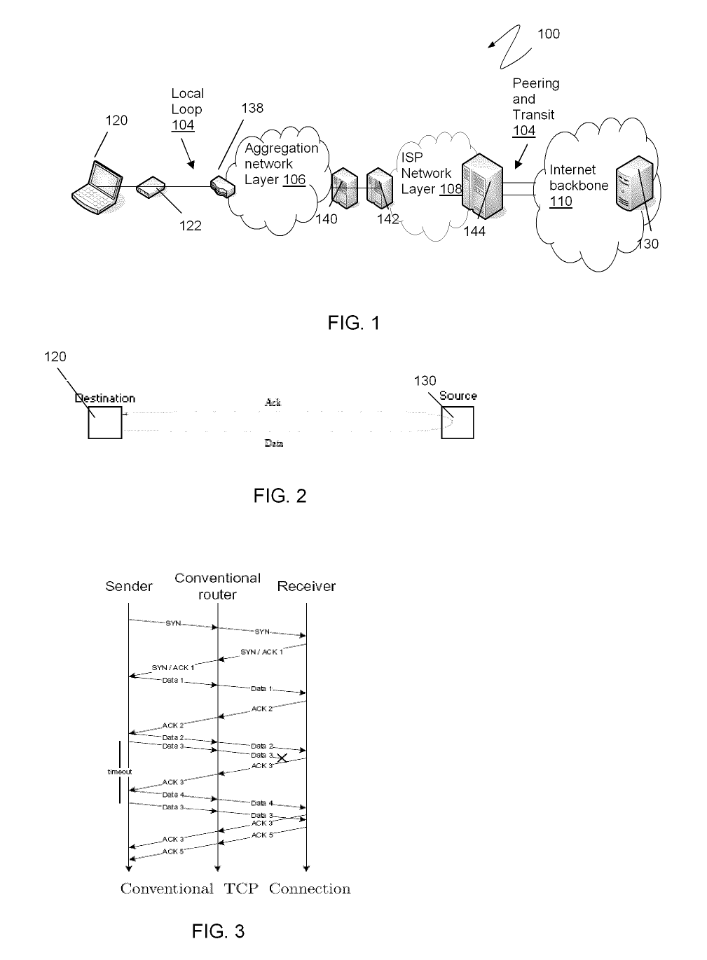

Reference is made to FIG. 1, which is a schematic diagram of a network 100 with which embodiments described herein may be used. Network 100 comprises a local loop 104, an aggregation network layer 106, a ISP network layer 108, and an internet backbone 110. A client 120 is coupled to local loop 104 through a Digital Subscriber Line (DSL) modem 122. Client 120 resides on any suitable computing device such, as for example, but not limited to, a laptop computer, desktop computer, smartphone, PDA, or tablet computer. Client 120 is typically operated by a subscriber of internet services provided by an internet service provider (ISP).

Client 120 communicates with server 130 through network 100. Server 130 is coupled to client 120 through internet back bone 110.

In various embodiments, local loop 104 comprises a telephony local loop that is comprised of copper wires.

A Digital Subscriber Line Access Multiplexer (DSLAM) 138 couples local loop 104 to aggregation network layer 106.

At the opposite edge of aggregation network layer 106 sits a Broadband Remote Access Server (BRAS) 140, which in turn is coupled to a Distribution Router 142. In various embodiments BRAS 140 is the closest IP node to client 120. Local loop 104 and aggregation network layer 106 are typically operated by a telephone company.

ISP network layer 108 spans between distribution router 142 and border exchange routers 144. ISP network layer 108 is operated by, for example, an ISP. Border exchange routers 144 are connected to internet backbone 110 or other networks through transit and peering connections 112. In this manner, ISP network layer 108 is connected to other networks such as, for example, but not limited to, network devices operated by content providers or other ISPs.

A problem with typical local loops is that they tend to have a higher degree of packet loss than other areas of network 100. In particular, local loop 104 can comprise older wiring than other portions of network 100. In addition, the length of local loop 104 is long and the quality of the transmission line is low as compared to other transmission lines in the rest of network 100. These factors contribute to greater number of errors occurring on the local loop 104 than other parts of network 104.

Aggregation network layer 106 can suffer from a greater degree of congestion than other portions of network 100.

### TCP

TCP is a reliable protocol that guarantees the delivery of content. This is achieved by a series of mechanisms for flow control and data control. Some of these features of TCP are also the source of some limitations of TCP. Some limitations of TCP include a slow start, bandwidth delay product, and congestion. The TCP protocol can also be negatively impacted by network latency and packet loss.

Reference is now made to FIG. 2, which illustrates a schematic diagram of a typical transmission control protocol (TCP) session between a client 120 and a server 130. Reference is also made to FIG. 3, which illustrates a schematic diagram of the data flow between client 120 and server 130. According to the TCP protocol, the data flowing between client 120 and server 130 is limited in part by the receipt of acknowledgments. Specifically, client 120 does not send additional data until an acknowledgment is received from server 130 that previously transmitted data has been received. If client 120 does not receive an acknowledgment after waiting for a predetermined amount of time, it may resend the data.

FIG. 2 omits the additional networking devices that sit between client 120 and server 130 given that in a traditional TCP session communication of the acknowledgements occurs between client 120 and server 130 and not other intervening network elements. For example FIG. 3 illustrates a single router 310 between client and server 130; however, as indicated, router 310 does not acknowledge receipt of data but merely retransmits acknowledgements received from either client 120 or server 130.

### Slow Start

An important aspect of a typical TCP operation is that the traffic flow goes through a slow start process. During this phase, the source host exponentially increases the amount of data that it sends out based on the receipt of ACK (acknowledgment) packets from the destination host. This makes the throughput highly dependent on the network latency (the round trip delay time or RTT).

### Network Latency

The speed of a TCP session is dependent in part on the distance between client 120 and server 130. More specifically, the speed is limited in part by the round trip delay time (RTT).

TCP is designed to implement reliable communication between two hosts. To do so, the data segments sent by the sender are acknowledged by the receiver. This mechanism makes TCP performance dependant on delay; the source host waits for the previous segment of data to be acknowledged by the destination host before sending another. The higher the delay, the lower the performance of protocols that rely on the sent/acknowledge mechanism.

### Bandwidth Delay Product

In the case of links with high capacity and high latency, the performance of a TCP session is further limited by the concept of “Bandwidth Delay Product” (BDP). This concept is based on the TCP window size mechanism that limits the maximum throughput of the traffic once the latency increases above a specific threshold. This is the so called “BDP threshold”.

In the case of a DSL highspeed internet connection, the higher the Sync

Rate of the service, the lower the latency threshold gets. This means that by increasing the Sync Rate of a service, the service provider would need to lower the network latency accordingly in order to fully benefit from the Sync Rate increase.

For example, a file transfer to Toronto from California (80 ms away), using standard/popular TCP attributes/behavior, can only achieve approximately 6.5 Mbps of throughput. Increasing the IP Sync Rate from 5 to 8 Mbps would not double the effective speed (from 5 to 10 Mbps) but would only increase it from 5 to 6.5 Mbps.

In order to reach the 8 Mbps speed with traditional TCP methods, the destination would need to be not more than 65 ms away from the source. As the end to end latency is hard limited to the optical speed of light, the effective TCP throughput would be lower than the service capacity, therefore impacting the subscriber's experience relative to the expectations.

### Network Latency And Packet Loss

In addition to the above-described limitations, the performance of TCP is also limited by the combination between Network Latency and Packet Loss.

Each packet loss instance triggers the congestion avoidance mechanism of TCP, which abruptly slows down the transmission rate of the source host followed by a linear recovery rate of that transmission rate.

Two factors that have an impact on the effective throughput in the presence of packet loss are:

(1) the amount of data that was sitting in transit buffers (typically the DSLAM buffer) when TCP went into congestion avoidance. The more data the DSLAM had in the buffers the less the impact of the congestion avoidance behavior. The less the Round Trip Delay is, the more data would be sitting in the DSLAM buffer; and

(2) the larger the Round Trip Delay is, the slower the recovery rate is from the congestion avoidance.

In order for the DSLAM to be able to deliver data at 100% of the service capacity, it serializes data continuously. This means that there should be no gaps between the data packets. This can be achieved, for example, if the DSLAM has data packets sitting in the port buffer ready to be serialized. Theoretically, the objective could be achieved even if there is only 1 packet always sitting in the buffer. However, in a real network, due to traffic flow inconsistencies (resulting from, for example, congestion, jitter, server limitations, etc) that 1 packet is generally not enough to sustain the throughput. Accordingly, a bigger number of buffered packets would provide protection against such network conditions affecting the serialization consistency, and thus the subscriber's speed.

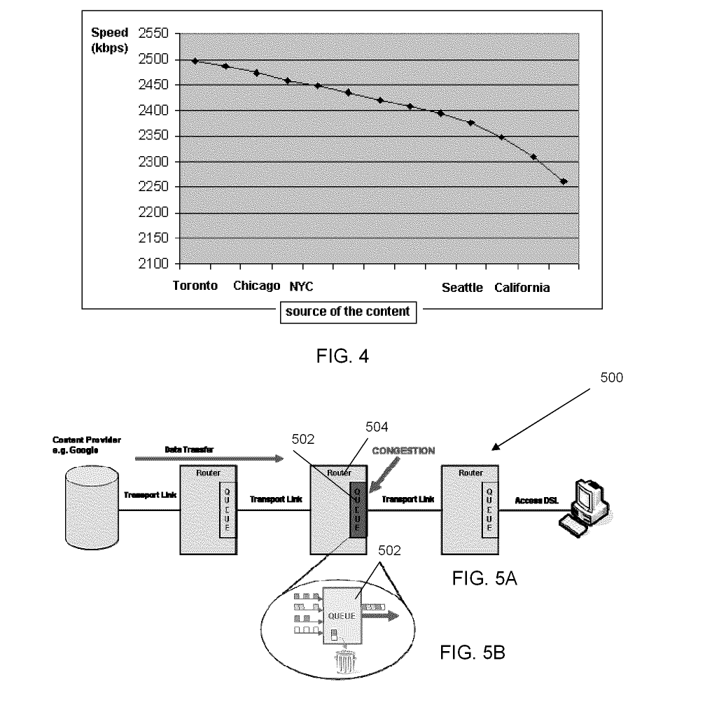

To properly assess the degree to which RTT impacts recovery from packet loss, extensive testing has been performed on a network for various sync rate profiles, and various combinations of packet loss and RTT. Reference is made to FIG. 4, which illustrates a graph showing the speed versus the RTT of the source of content. The example used is for a non-interleaving X Mbs profile and 0.5% packet loss (file download speed). The X axis is expressed in 10 ms increments (from 12 ms to 132 ms RTT)

Overall, the impact of latency on the speed degradation due to packet loss is cumulative. With the increase of latency, less data would be buffered at the DSLAM level therefore there would be less protection to packet loss effects. In addition, the recovery from a packet loss instance (from congestion avoidance) will take more time.

### Congestion

Reference is made to FIGS. 5A and 5B, which illustrate schematic diagrams of a network 500 and a queue 502 of a network device 504 respectively. Some network devices receive data from a variety of sources. The data that is received is stored in a queue and then serialized and outputted to the next network device as shown in FIG. 5B. Congestion can occur in a network element, such as for example, router 504, when the combined rate of data inflowing into the network device exceeds the serialization rate of that network device.

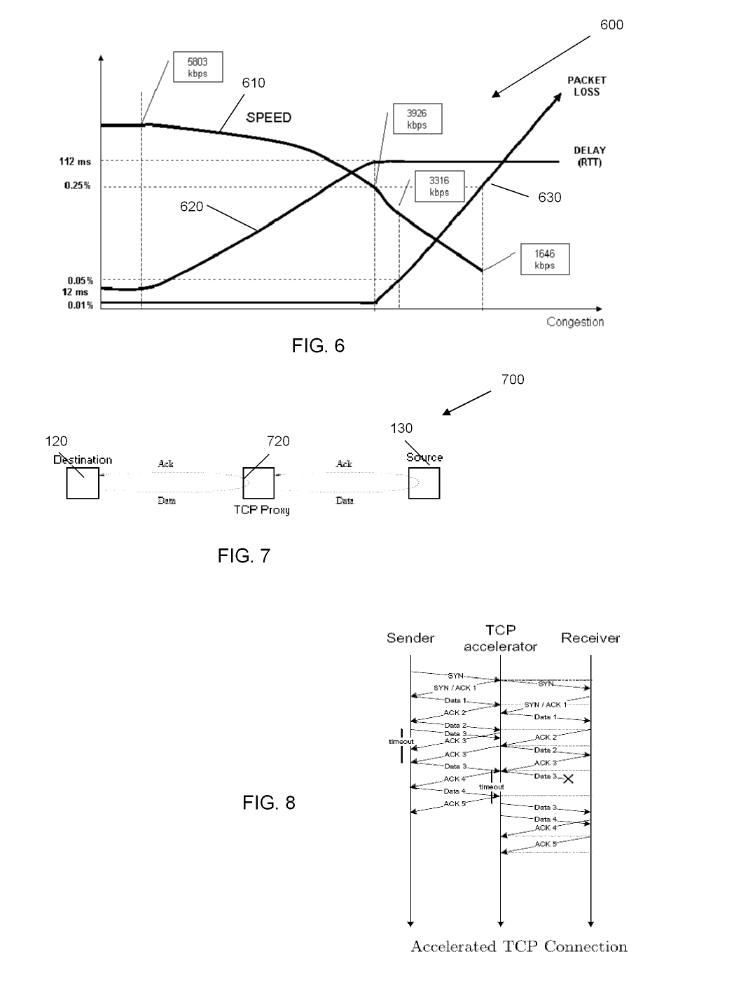

Reference is now made to FIG. 6, which illustrates a graph 600 comprising three curves 610, 620, and 630 superimposed on one another. Graph 600 is based on a 7 Mbps DSL internet service. Curve 610 illustrates the speed of a file download as a function of congestion. Curve 620 illustrates delay (RTT) or latency as a function of congestion. Curve 630 illustrates packet loss as a function of congestion. The baseline is based on a 0.01% packet loss and 12 ms latency (local content).

Congestion can be roughly divided into three phases: low congestion, medium congestion, and high congestion.

In low congestion, a network device experiencing congestion will start to buffer the outgoing data in its transmit buffers. This causes the data to be delayed but it is not discarded. This TCP response is based on the assumption is that the congestion event will not have an overly long duration such as for example simply a spike in traffic. Accordingly, low congestion does not impact packet loss but it is characterized in a spike of RTT (jitter) for the duration of the congestion.

Medium congestion occurs when the congestion event is prolonged. The buffer is therefore used for a longer period of time to avoid packets in transit from being dropped. Medium congestion does not impact pack loss. However, it is characterized in an increase in the RTT for the duration of congestion. As the buffer utilization level varies in time, jitter will also be seen.

High congestion occurs when the buffer becomes full and the network device starts to tail-drop, which causes packets to be lost. At this point the TCP traffic will start to back-off. Accordingly, high congestion is characterized by packet loss (depending on the tail-drop severity) and has the highest latency impact of the three types of congestion.

As can be seen from FIG. 6, as congestion begins, latency increases gradually. The more latency that is added, the lower the effective speed. After the point where the congestion triggers tail drops, the latency remains the same but the packet loss rate increases.

In a network that is not congestion aware, the TCP congestion avoidance mechanisms will ensure that dropped data will be retransmitted. However, at the same time, the TCP protocol's congestion avoidance scheme triggers a slow-down in the throughput for that TCP session.

As packet loss due to congestion occurs only during severe congestion, at that point, the latency is already at its maximum, maximizing the impact of packet loss on the throughput. In addition to that effect, when severe congestion occurs, the packets that have been dropped will be retransmitted, therefore more traffic has to be passed through the network for the delivery of the same content (lower goodput).

These effects result in slow speeds experienced by the subscriber operating client 120 and therefore negatively impacts their experience.

TCP overlay network

Reference is next made to FIG. 7, which illustrates a schematic diagram of system 700 for providing a TCP session between client 120 and server 130 according to various embodiments. In various embodiments, system 700 resides in network 100 of FIG. 1. System 700 comprises a transparent proxy system 720 that resides in a traffic path between client 120 and server 130. When client 120 initiates a TCP session to server 130, proxy system 720 terminates the client's session transparently. Proxy system 720 then initiates a different TCP session to server 130, using the client's source IP.

In various embodiments, system 700 comprises a TCP overlay network. In some embodiments, the TCP overlay network comprises a network of logical and/or physical elements, such as, for example, one or more proxy system 720, built on top of another network. The one or more proxy system 720 act at OSI layer 4 (transport) and split the TCP connections into two or more segments.

Reference is now made to FIG. 8, which is schematic diagram of the data transmitted in system 700 of FIG. 7 according to various embodiments. Upon receipt of data from client 120, proxy system 720 retransmits the data to server 130 and transmits and acknowledgment to client 120 prior to receiving an acknowledgment from server 130. This allows client 120 to transmit new information sooner as compared to the traditional TCP scenario described above. It should be understood that proxy system 720 transmits acknowledgments in an analogous manner when server 130 transmits data to client 120.

A client connects to proxy system 720, requesting some service, such as a file, connection, web page, or other resource, available from a different server. Proxy system 720 evaluates the request according to its filtering rules. For example, it may filter traffic by IP address or protocol. If the request is validated by the filter, the proxy provides the resource by connecting to the relevant server and requesting the service on behalf of the client. Proxy system 720 may optionally alter the client's request or the server's response, and sometimes it may serve the request without contacting the specified server. In this case, it ‘caches’ responses from the remote server, and returns subsequent requests for the same content directly. This feature will be explained in greater detail below.

A proxy server has many potential purposes, including: to keep machines behind it anonymous (mainly for security); to speed up access to resources (e.g. web proxies are commonly used to cache web pages from a web server); to apply access policies to network services or content (e.g. to block undesired sites); to log/audit usage (e.g. to provide company employee Internet usage reporting); to bypass security/parental controls; to scan transmitted content for malware before delivery; to scan outbound content (e.g., for data leak protection); to circumvent regional restrictions.

In some embodiments, proxy system 720 has a solid fail-over mechanism that in case of any hardware or software failures, proxy system 720 can take itself offline and allow the traffic to bypass the system without impacting the performance of the traffic path (or with minimal impact on the performance of the traffic path). In various embodiments, system 700 is scalable and can be managed out-of-band. System 700 can also communicate in real-time with third party tools and systems. Specific reports and alarms can be sent by the system to third party tools. In some embodiments, the event reporting could be SNMP compatible. In other embodiments, the reporting is implemented to be compatible with propriety systems.

In various embodiments, proxy system 720 is a transparent proxy system. In particular, in various embodiments, neither client 120 nor server 130 are aware of proxy's 720 existence or involvement in the TCP session. The present system ensures that neither the client nor the server sees the system's intervention so that both the source (the client's) internet protocol (IP) and the destination (the server's) IP are preserved by the system. For example, in the scenario described above in relation to FIGS. 7 and 8, from the perspective of server 120, the acknowledgement that actually originates from proxy system 720 appears to originate from client 130.

Proxy system 720 takes over the delivery of the content towards the subscriber (client 120) on behalf of the real server (server 130) and vice-versa without affecting the standard way TCP operates. By receiving packets and acknowledging them to the sender before they arrive at the receiver, proxy system 720 takes over the responsibility of delivering these packets. In some embodiments, typical behaviour of proxy system 720 includes: immediate response to the sender (from that moment on the proxy is responsible for the data packet), local retransmissions (locally retransmitted packets when they are lost), flow control back pressure (slows down on the traffic flow from the source when the local buffer fills up).

A transparent proxy, that does not modify the request or response beyond what is required for proxy identification and authentication, can be implemented, for example, with the Web Cache Communication Protocol (WCCP), developed by Cisco Systems. WCCP specifies interactions between one or more routers (or Layer 3 switches) and one or more web-caches. The purpose of the interaction is to establish and maintain the transparent redirection of selected types of traffic flowing through a group of routers. The selected traffic is redirected to a group of web-caches with the aim of optimizing resource usage and lowering response times.

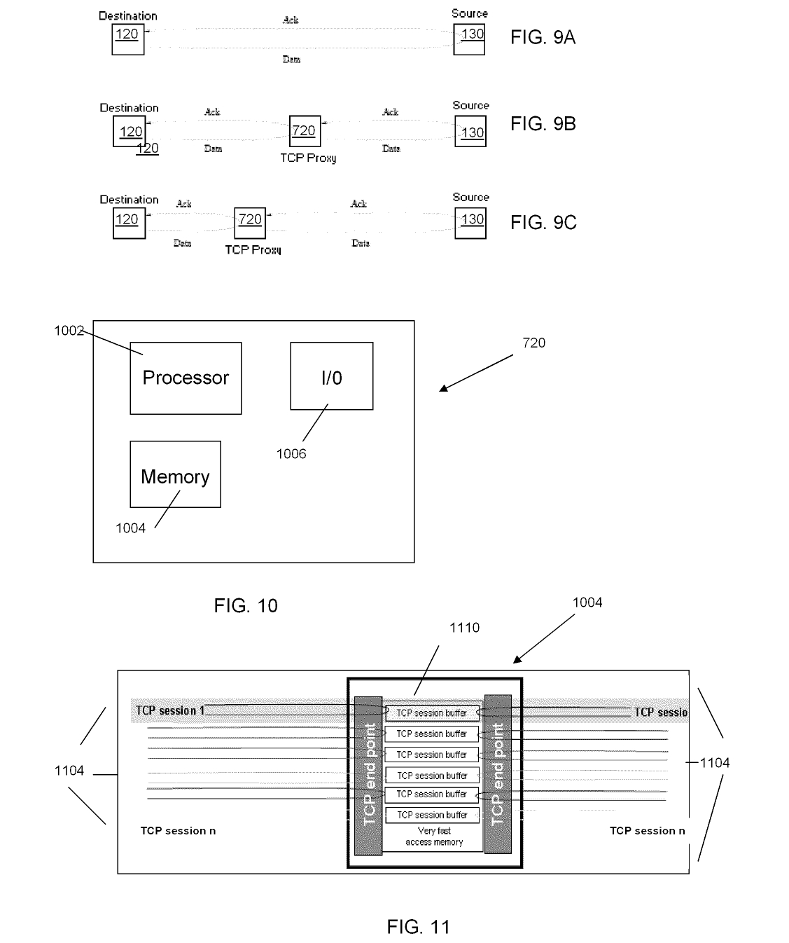

Reference is now made to FIGS. 9A to 9C, which are schematic diagrams of various TCP sessions between a sender and a recipient, where the sender is located in Ontario, Canada and the recipient is located in California, USA. In such a case, the total RTT can for example be 80 ms. The sender can for example be a client 120 and the recipient can be server 130. In some cases, the sender can be referred to as the destination and the recipient can be referred to as the source given that the sender requests information from the recipient, which is the source of the data and the data is transmitted from the source to the destination.

FIG. 9A illustrates the case where no proxy system is used between the sender and recipient. FIG. 9B and FIG. 9C illustrate embodiments where a proxy system 720 is used between the same sender and recipient as in FIG. 9A. In FIG. 9B, the proxy system 720 is placed such that the RTT between the proxy and the sender as well as the proxy system 720 and the recipient is 40 ms each. In FIG. 9C the proxy is placed such that the RTT between the proxy and the sender 20 ms and the RTT between proxy and the recipient is 60 ms.

Consider a first scenario for FIGS. 9A to 9C in which the network between the sender and recipient is homogeneous in the sense that different portions of the network cannot be distinguished on factors that affect RTT, such as for example pack loss and congestion. In the case of FIG. 9A, the maximum throughput achievable is approximately 6.5 Mbps. In the case of FIG. 9B, the maximum throughput achievable is approximately 13 Mbps. In the case of FIG. 9A, the maximum throughput achievable is approximately 6.5 Mbps. Accordingly, the use of a proxy server to break up a single TCP session into multiple sessions can reduce the RTT and increase the overall throughput. The overall throughput is limited in part by the segment with the highest RTT.

Consider a second scenario for FIGS. 9A to 9C in which the network between the sender and recipient is not homogeneous. Specifically, consider the case for a 7 Mbps DSL service in which the first 20 ms from the sender includes a local loop with a packet loss of 0.25%. For this scenario, in the case of FIG. 9A, the maximum throughput will be approximately 2.2 Mbps. Similarly, in the case of FIG. 9B, the maximum throughput will be approximately 4.1 Mbps. Finally, in the case of FIG. 9C, the proxy sits immediately between the local loop and the rest of the network, the maximum throughput will be approximately 5.7 Mbps. By reducing the latency to 20 ms on the network segment that is the cause of the packet loss, the effective throughput is increased from 2.2 Mbps to 5.7 Mbps. Accordingly, in some embodiments, an additional benefit of reducing the RTT for a TCP session is that there is a faster recovery for throughput when packet loss occurs.

Accordingly, by reducing the latency on a TCP segment, the overall speed increases. By splitting a TCP session into multiple segments with lower latency each, the overall speed increases up to the speed of the slowest segment.

Due to the large number of factors that can cause errors on the local loops, most of the packet loss (except for severe congestion events) is generated on this network segment. By capturing this network segment within a low latency TCP segment, proxy system 720 can limit the impact of these errors on the speed of the TCP session. By lowering the latency on the TCP segment terminating on the subscriber's client 120, which resides on the customer provided equipment (CPE), to a low level (10 ms) the effective speed that could be achieved on this TCP segment is at least 50 Mbps, enabling high speed Fiber-to-the-node (FTTN) subscribers to reach higher speeds. As the local loop errors will now have a much lower impact on speed, these errors become more tolerable. Therefore these local loops need not be replaced with more reliable transmission lines to achieve greater speeds than are presently available using known methods and systems.

### Buffering

In various embodiments, proxy system 720 buffers data transmitted during the TCP session. In the case of an end to end TCP session, a buffering point on the path, such as proxy system 720, can sustain the downstream throughput from the cache when congestion events affect the throughput on the upstream segment.

In various embodiments, proxy system 720 buffers content when data is received from the server faster than the system can transmit the data to the client in order to sustain the outbound throughput in case the inbound throughput gets affected. In an efficient example, the buffer of the system is full and the inbound rate is equal to the outbound rate, so the buffer becomes the “reservoir” for data in case the inbound data rate drops below the outbound data rate. In various embodiments, this is facilitated by the high speed link that proxy system 720 has towards the source of the content, allowing for generally higher inbound rates than outbound to the client, thus allowing for the creation and replenishing of the buffer (the content reservoir). Due to the availability of data in the local buffer and the lower delay on the downstream TCP segment the throughput towards the subscriber can be sustained for longer and, in case of packet loss, can recover faster.

In various embodiments, the buffer is allocated dynamically from a pool of available fast access memory. In some embodiments, each established TCP session has it's own buffer, up to a maxBufferSize (configurable). Upon completion of the TCP session (connection reset) the buffer is allocated to the free memory pool.

In some embodiments, in the extreme case that no more memory is available for buffer allocation, proxy system 720 starts a session with a zero buffer size, and as memory becomes available it allocated to that session. In various embodiments, the larger a buffer becomes the less priority it has for growth.

Reference is now made to FIG. 10, which illustrates a block diagram of proxy system 720 according to various embodiments. Proxy system 720 comprises a processor 1002, a memory 1004 and an input output module 1006.

Proxy system 720 can comprise a stand alone device incorporated into network 100. Alternatively, proxy system 720 can be incorporated into an existing device in network 100 such as, for example, but not limited to, BRAS, or a blade server. In some embodiments, various components of proxy system 720 can be distributed between multiple devices on network 100.

In some embodiments, proxy system 720 is placed as close as possible to client 120 but still in an IP network layer. Accordingly, in various embodiments, proxy system 720 placed at the edge of the closest IP network layer to client 120. In some embodiments, the term “at the edge of a network layer” means close to, but not necessarily at, the interface between that network layer and an adjacent network layer. In other words, the term “the edge of a network” comprises (1) the interface between that network and another network, as well as (2) other network devices within that network that are coupled to (directly or indirectly) the interface device. In some embodiments, “close to” means not more than 3 network devices away from. In other embodiments, “close to” means not more than 2 network devices away from. In other embodiments, “close to” means not more than 1 network devices away from. In other embodiments, “close to” can mean more than 3 network devices away from.

In various embodiments, proxy system 720 is placed at the interface between the closest IP network layer to the client and the next network layer closer to client 720, such as for example, at the interface between ISP network layer 108 and aggregation network layer 106. In various embodiments, ISP network 108 is an IP network layer while aggregation network layer 106 is not an IP network layer. In some embodiments, proxy system 720 is situated in ISP network layer 108. In some embodiments, proxy system 720 is placed at the edge of the ISP network layer 108 closest to the client. In some embodiments, proxy system 720 is placed at the interface between ISP network layer 108 and aggregation network layer 106.

In some embodiments, BRAS 140 is a device that interfaces between the IP network layer and the non-IP network layer closest to client 120. Accordingly, as mentioned above, in some embodiments, client 120 is incorporated into BRAS 140. In some other embodiments, client 120 is placed in ISP network layer 108 close to BRAS 140. In some future embodiments, BRAS 140 and DSLAM 138 may be implemented in a single combined device. In such embodiments, proxy 120 may be implemented in this combined device. In some embodiments, multiple proxy systems are used in a cascaded manner. This will be described in greater detail below.

Reference is now made to FIG. 11, which illustrates a schematic diagram of memory 1004. In various embodiments, memory 1004 comprises any suitable very fast access memory. Memory 1004 is allocated to a plurality of TCP session buffers 1110 for buffering data transmitted during each of a plurality of TCP session 1114. In some embodiments, each TCP session buffer 1110 is a dedicated buffer. In various embodiments, the buffer size is controlled by the management tools, and may be increased as required. As the TCP throughput between proxy system 720 and server 130 can be higher than the TCP throughput between proxy system 720 and client 120, proxy system 720 can buffer the excess data received from server 130, up to the maximum buffer size. As the buffer gets full, proxy system 720 triggers a “buffer full” behavior, that slows down the traffic flow from the server, for example, by slowing down on sending the TCP acknowledge packets to the server, in order to run a full buffer size but avoid buffer overrun.

In various embodiments, the processing power of processor 1002 and the size of memory 1004 are selected to be any appropriate value based on such factors as the traffic volume. On a 1 Gbps line there can be thousands of parallel TCP sessions. Similarly, on a 10 Gbps line, there can be tens of thousands of parallel TCP sessions. Managing that many TCP sessions can be very resource intensive in terms of CPU processing power and memory usage. Buffering the content for that many sessions could also be resource intensive. In some embodiments, proxy system 720 buffers on average 1 MB/session and therefore memory 1004 is selected to provide a few GB of cache for 1 Gbps of traffic. It should be understood that any suitable value can be selected.

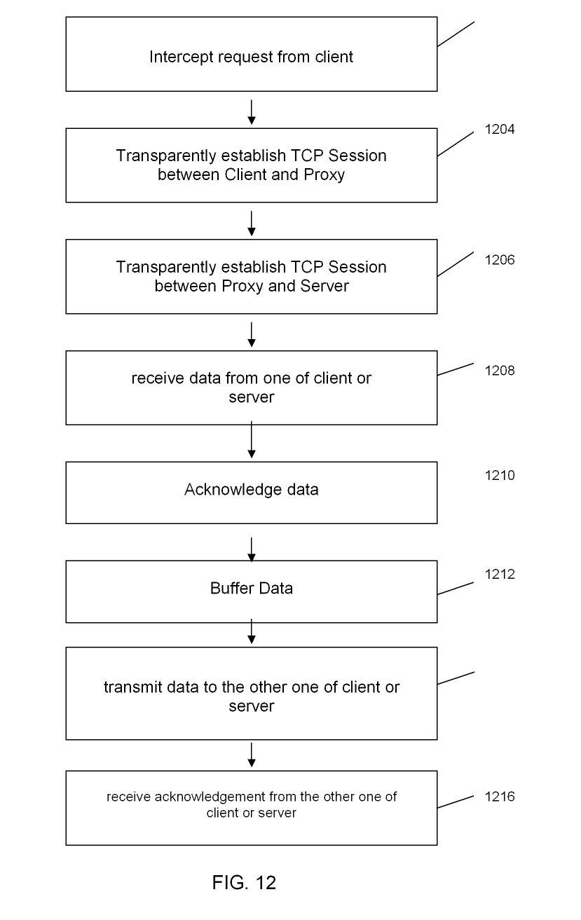

Reference is now made to FIG. 12, which is a flow chart diagram illustrating a method performed by proxy system 720 according to various embodiments.

At 1202, proxy system 720 intercepts a request from client 120.

At 1204, proxy system 720 transparently establishes a TCP session between client 120 and proxy system 720.

At 1206, proxy system 720 transparently establishes a TCP session between server 130 and proxy system 720.

At 1208, proxy system 720 receives data from either client 120 or server 130.

At 1210, proxy system 720 acknowledges the data by transmitting an acknowledgment to the one of the client 120 or server 130 that transmitted the data. Accordingly, if client 120 transmitted the data, then proxy system 720 transmits the acknowledgement to client 120. Similarly, if server 130 transmitted the data, then proxy system 720 transmits the acknowledgement to server 130.

At 1212, proxy system 720 buffers the data that was received. There are two types of buffering that occur. If the data is received from server 130, then proxy system 720 buffers the data in part to build a reserve of data that can be transmitted to client 120 when a congestion event slows down the TCP session between server 130 and proxy system 720. Accordingly, data that has been received by the proxy system 720 and has not yet been transmitted is buffered.

In addition, data is briefly buffered regardless of where it is received. As described above, in various embodiments, proxy system 720 takes over responsibility from the sender to ensure that the data is in fact received at the recipient. Accordingly, proxy system 720 buffers data even if the data is immediately retransmitted after its receipt. This is done so that, for example, the data can be retransmitted if an acknowledgement is not received from the recipient.

At 1214, proxy system 720 transmits data to the other one of the client 120 or server 130 to which the data was directed. Accordingly, if client 120 transmitted the data and server 130 was the intended recipient, then proxy system 720 transmits the data to server 130 and vice versa.

At 1216, proxy system 720 receives an acknowledgement form the one of the client 120 and server 130 to which the data was sent. At this point, proxy system 720 can purge the data that was sent from its buffer.

### Congestion Awareness

In some embodiments, system 700 comprises a congestion aware network. The congestion aware network identifies a congestion event before congestion becomes severe. In various embodiments, the congestion awareness is provided by proxy system 720. Proxy system 720 interacts with the TCP sessions in a way that avoids the impact of severe congestion. Specifically, in various embodiments, this can be achieved through the use of a proxy system 720 that faces the network segment that is experiencing the congestion.

As described above, aggregation network layer 106 of network 100 is often more prone to congestion than other portion of network 100. Accordingly, in various embodiments, proxy system 720 is situated on the edge of aggregation network layer 106 closest to local loop 104.

When a network link experiences congestion, then all the TCP sessions going through that link experience and increase in RTT. Accordingly, an increase in RTT is an indicator that congestion is occurring on that link. In various embodiments, each TCP session is associated to a path through the network based on the subscriber's IP (internet protocol) address. More particularly, the IP address is associated with a Permanent Virtual Path (PVP) and a PVP is associated with a network path.

Accordingly, in various embodiments, the proxy system 720 monitors the RTT for all the TCP sessions passing through it and monitors for the above-described indicators. In this manner, proxy system 720 is able to flag a link as being congested before congestion becomes severe and before the congestion affects the throughput significantly.

At that point in time, proxy system 720 is able to fairly manage the way the traffic will be delivered through that congested link. In various embodiments, proxy system 720 achieves this by buffering the traffic in excess at the IP level, instead of dropping it by a TX queue. Proxy system 720 serves the affecting TCP sessions with content from the queues in a non blocking mode, so that there is no session starvation or user starvation. In some embodiments, the round robin method is subscriber agnostic in the sense that all subscribers are treated equally. In other embodiments, in determining how each subscriber is dealt with, consideration is taken of the type of service each subscriber has, which can for example be identified by the subscriber's IP address. In this manner, proxy system 720 can deliver fairness at the subscriber level or just at the session level.

In various embodiments, delivering fairness at the subscriber level ensures that if a subscriber pays for 10 Mbps, then the subscriber gets double the speed provided to a subscriber that only pays for 5 Mbps, such that each subscribers experience is proportionate to the speed of the service that the subscriber pays for.

In various embodiments, by buffering the traffic, proxy system 720 is able to sustain a prolonged full utilization of a link. Specifically, in some embodiments, proxy system 720 has buffered content that helps to ensure that the link will not be underutilized and thereby, maximizing the overall utilization levels.

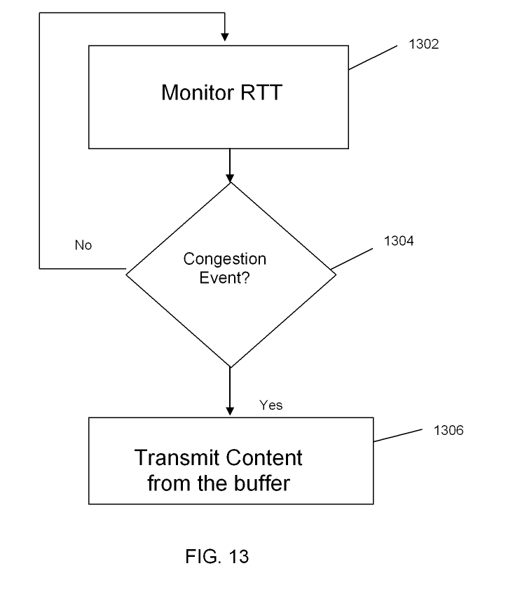

Reference is now made to FIG. 13, which illustrates a method utilized by proxy system 720 to counter the effects of congestion according to various embodiments. At 1302, proxy system 720 monitors RTT of the various TCP sessions. In some embodiments, the RTT of the sessions between proxy system 720 and server 130 is monitored. In some embodiments, the RTT of the sessions between proxy system 720 and server 130 as well as the sessions between proxy system 720 and client 120 are monitored.

At 1304, proxy system 720 determines if a congestion event has begun to occur. This determination can be done in any appropriate manner, such as, for example, a rise in the RTT time over a predetermined threshold. If a congestion event is not identified, then proxy system 720 continues to monitor for a congestion event.

If a congestion event has been identified, then at 1306, proxy system 720 begins to deplete the content from the buffer for the affected TCP session. In particular, content from the buffer is forwarded to the client in order maintain the subscriber's experienced speed for the TCP session.

### Customizing the TCP Attributes

The BDP threshold can be determined by the following formula:

MaxTCP_WinSize/Sync_rate.

In various embodiments, the MaxTCP_WinSize is often 65 KB.

The higher the Sync rate, the lower the BDP threshold. For example, for an IP Sync rate of 16 Mbps, the threshold is 33 ms. This means that any TCP session with an RTT beyond 33 ms will have an effective throughput below the IP Sync rate.

In various embodiments, the MaxTCP_WinSize (Transmit Window at the source) is increased and therefore the BDP threshold is increased. This in turn reduces the impact of latency on the speed of the TCP session. In various embodiments, proxy system 720 negotiates a higher MaxTCP_WinSize with the client.

For example, by splitting an 80 ms latency in half, the maximum speed can be increased from 6.5 Mbps to 13 Mbps due to reducing the RTT on the two TCP segments. On top of this, by negotiating a MaxTCP_WinSize of 128 KB instead of the usual 65 KB, the maximum speed on the last TCP segment (the one between the subscriber and proxy system 720) is increased to 25.6 Mbps.

In various embodiments described herein, a TCP overlay network gives control over the TCP settings of the source end on all the segments except the ones terminating on the real source server. In this manner, the TCP segment between the subscriber and proxy system 720 can have its TCP settings configured to achieve higher speeds.

In various embodiments, other TCP settings that are used in order to maximize the speed and efficiency of the links. For example, in some embodiments, TCP settings related to the early congestion notification mechanisms (ECN, RED) that are not normally enabled on public networks, are utilized on the TCP segments in-between the TCP proxies.

In various embodiments, the use of a TCP overlay network in accordance with embodiments described herein can:
reduce the effects of errors on the local loops, on the TCP performance
reduce the impact on performance of network congestion in the Aggregation network
maximize the speed that can be achieved on existing DSL services, by increasing the sustained throughput
increase the QoE for the popular HD content, that will now be served right from proxy system 720 cache, at a higher, sustained throughput

### Cascaded TCP Proxies

It should be understood that although much of the description relates to a single proxy system 720, some embodiments utilize a plurality of cascaded proxies 720. In such embodiments, an original end-to-end TCP connection is split into more than two segments. In some embodiments, the determination of which network segments are split into two higher performance network segments, is made based on how high the RTT for that segment is. In other words, in some embodiments, a segment with a high RTT is split before a segment with a lower RTT is split. In addition, the more packet loss a particular network segment has, the higher the importance to capture that segment in a low RTT TCP segment. Accordingly, in various embodiments, a proxy system 720 is placed next to local loops given that local loops can suffer from higher packet losses than other portions of the network.

For example implementing a TCP overlay network with 3 segments that have 25 ms will enable a TCP throughput between the West and the East Coast to be 21 Mbps, compared to only 7 Mbps that we can be achieved with known methods (assuming a 75 ms RTT).

### Caching

In various embodiments, proxy system 720 caches popular web objects to increase the speed at which subscribers can download these objects.

In various embodiments, proxy system 720 looks into a hypertext transfer protocol (HTTP) session and rank the popularity of particular web objects, such as images, videos, files, being downloaded by a client. Based on a configurable decision mechanism, the objects that are being ranked above a threshold can be cached on local storage device, such as a fast access storage, so that any subsequent request for that object would be delivered from the local cache. Proxy system 720 cache web objects instead of full web pages and can cache popular files being downloaded by a client.

In various embodiments, caching is performed in a manner that does not affect the dynamic of the applications. For example in the case of web pages, proxy system 720 ensures that object caching does not deliver outdated content to the subscribers. In particular proxy system 720 ensures that outdated web objects are not cached. Proxy system 720 performs a similar function for other applications as well.

The above-described embodiments of the invention are intended to be examples only. Alterations, modifications and variations can be effected to the particular embodiments by those of skill in the art without departing from the scope of the invention, which is defined solely by the claims appended hereto.

1. A method for increasing the performance of a transmission control protocol (TCP) session transmitted over a telephony local loop between a client and a server, the method comprising:
providing a proxy system between the client and the server,
the client and the server being coupled through a network, the network comprising:
a telephony local loop,
an internet backbone, and
an IP network layer between the telephony local loop and the internet backbone, the IP network layer having a first edge, the first edge comprising a first interface, the IP network layer being coupled to the client through the first interface,
the client being coupled to the telephony local loop,
the server being coupled to the client through the internet backbone,
the proxy system being situated at the first edge of the IP network layer;
intercepting, at the proxy system, a request transmitted by the client;
transparently establishing a first TCP session between the client and the proxy system, and a second TCP session between the proxy system and the server; and
storing data, received from the server in response to the request, in a buffer at the proxy system, when throughput between the server and proxy system is greater than throughput between the proxy system and the client.

2. The method of claim 1, wherein the proxy system resides at the first interface.

3. The method of claim 1, wherein the network further comprises:
an aggregation network layer, the aggregation network layer being a non-IP network layer;
wherein the aggregation network layer is coupled between the telephony local loop and the first edge of the IP network layer, the aggregation network layer being coupled to the IP network layer at the first interface; and
wherein the proxy system resides at the first interface.

4. The method of claim 1, wherein the proxy system resides in a broadband remote access server (BRAS).

5. The method of claim 1, further comprising:
in response to data received from the client at the proxy system:
transmitting the data from the proxy system to the server; and
prior to receiving an acknowledgment from the server at the proxy system, transmitting an acknowledgment from the proxy system to the client.

6. The method of claim 5, wherein the acknowledgment transmitted by the proxy system appears to originate from the server.

7. The method of claim 1, further comprising monitoring the round trip delay time (RTT) of the TCP session between the proxy system and the server.

8. The method of claim 7, further comprising:
identifying a congestion event when the RTT exceeds a threshold; and
if a congestion event has been identified, transmitting data from the buffer to the client during the congestion event to maintain throughput between the proxy system and the client.

9. The method of claim 1, further comprising selecting a TCP window size to maximize throughput.

10. The method of claim 1, further comprising caching web content at the proxy system.

11. A system for increasing the performance of a transmission control protocol (TCP) session transmitted over a telephony local loop between a client and a server, the system comprising:
a proxy system between the client and the server,
the client and the server being coupled through a network, the network comprising:
a telephony local loop,
an internet backbone, and
an IP network layer between the telephony local loop and the internet backbone, the IP network layer having a first edge, the first edge comprising a first interface, the IP network layer being coupled to the client through the first interface,
the client being coupled to the telephony local loop,
the server being coupled to the client through the internet backbone,
the proxy system being situated at the first edge of the IP network layer, the proxy system comprising:
a buffer memory; and
a processor, the processor configured to:
intercept, at the proxy system, a request transmitted by the client;
transparently establish a first TCP session between the client and the proxy system, and a second TCP session between the proxy system and the server; and
store data, received from the server in response to the request, in the buffer memory, when throughput between the server and proxy system is greater than throughput between the proxy system and the client.

12. The system of claim 11, wherein the proxy system resides at the first interface.

13. The system of claim 11, wherein the network further comprises:
an aggregation network layer, the aggregation network layer being a non-IP network layer;
wherein the aggregation network layer is coupled between the telephony local loop and the first edge of the IP network layer, the aggregation network layer being coupled to the IP network layer at the first interface; and
wherein the proxy system resides at the first interface.

14. The system of claim 11, wherein the proxy system resides in a broadband remote access server (BRAS).

15. The system of claim 11, wherein the processor is further configured to:
in response to data received from the client at the proxy system:
transmit the data from the proxy system to the server; and
prior to receiving an acknowledgment from the server at the proxy system, transmit an acknowledgment from the proxy system to the client.

16. The system of claim 15, wherein the processor is further configured to transmit the acknowledgement such that the acknowledgment appears to originate from the server.

17. The method of claim 11, wherein the processor is further configured to monitor the round trip delay time (RTT) of the TCP session between the proxy system and the server.

18. The system of claim 17, wherein the processor is further configured to:
identify a congestion event when the RTT exceeds a threshold; and
if a congestion event has been identified, transmit data from the buffer to the client during the congestion event to maintain throughput between the proxy system and the client.

19. The system of claim 11, wherein the processor is further configured to select a TCP window size to maximize throughput.

20. The system of claim 11, wherein the processor is further configured to cache web content at the proxy system.

21. A method for increasing the performance of a transmission control protocol (TCP) session transmitted over a telephony local loop between a client and a server, the method comprising:
providing a proxy system between the client and the server, the client and the server being coupled through a network;
intercepting, at the proxy system, a request transmitted by the client;
transparently establishing a first TCP session between the client and the proxy system, and a second TCP session between the proxy system and the server; and
storing data, received from the server in response to the request, in a buffer at the proxy system, when throughput between the server and proxy system is greater than throughput between the proxy system and the client.
